(19) United States
(12) Patent Application Publication
(10) Pub. No.: US 2014/0230253 A1
(43) Pub. Date: Aug. 21, 2014

(54) HANDHELD KITCHEN UTENSIL

(71) Applicant: Ohad Ancsel, Tel Aviv (IL)

(72) Inventor: Ohad Ancsel, Tel Aviv (IL)

(73) Assignee: OR NOVELTIES LTD., Tel Aviv (IL)

(21) Appl. No.: 14/347,135

(22) PCT Filed: Sep. 13, 2012
(86) PCT No.: PCT/IL2012/050366

§ 371 Date: Mar. 25, 2014

Related U.S. Application Data
(60) Provisional application No. 61/539,010, filed on Sep. 26, 2011.

(51) Int. Cl. A47J 17/02

(52) U.S. Cl. CPC A47J 17/02
USPC 30/123.5

(57) ABSTRACT

Provided is a handheld kitchen utensil including a frame; a cutting blade; and a spacer plate, the cutting blade and the spacer plate being pivotally mounted to the frame. The cutting blade and spacer plate may be pivotally displaceable between at least a peeling position and at least one slicing position.

### TECHNOLOGICAL FIELD

This disclosed subject matter relates to handheld kitchen utensils and more specifically it is concerned with a kitchen utensil for at least pealing and slicing of food products.

### PRIOR ART AND BACKGROUND

References considered to be relevant as background to the presently disclosed subject matter are listed and briefly described below:

U.S. Pat. No. 3,956,825 is directed to a vegetable peeler in one version that is pushed against the vegetable and removes the skin by an impressed blade; in another version, a relatively long blade is rotatable in a frame to remove a variable thickness of the vegetable at each stroke.

US2006037201 is directed to a vegetable peeler having two gripping surfaces connected to each other by a peeling blade as well as a cross-piece. According to the publication, the two lateral gripping surfaces and the interconnecting cross-piece are forming a holder, the dimension of the legs (L) of the U-shaped holder being shorter in peeling direction (A) than the distance (B) between the gripping surfaces. In this way, direct guiding the peeling blade is enabled without any lever arm. The peeling blade, when used, is directly between the fingers and, therefore, can be guided in an extremely precise, handy and safe way.

WO08087462 is directed to a hand operated peeler for vegetables, that directs the peels up-and sidewards for easy lifting off and prevents their re-adhering to the peeled object. Therefore a discharge section behind the blade is curved in two dimensions and coated with a non-stick layer, the discharge section being part of the blade or closely adhering to it. For adaptation to a preferred working angle, the blade unit can be mounted into the open segment of a sliding ring, which permits swivelling adaptation.

Acknowledgement of the above references herein is not to be inferred as meaning that these are in any way relevant to the patentability of the presently disclosed subject matter.

### GENERAL DESCRIPTION

According to the present disclosed subject matter there is provided a multi-task handheld kitchen utensil for at least pealing and slicing of food products.

The term food products refers among others to vegetables, fruits, chesses, nuts, meat, poultry, etc.

According to the present disclosed subject matter there is disclosed a handheld kitchen utensil comprising a frame configured with a cutting blade and a spacer plate, both of which being pivotally mounted to the frame about parallely extending axes; said cutting blade and spacer plate being pivotally displaceable between at least a peeling position and at least one slicing position.

The arrangement is such that at the peeling position the cutting blade extends inclined with respect the spacer plate such that a cutting edge of the cutting blade extends below a bottom surface of the spacer plate. At the peeling position the spacer plate is configured to follow an outer surface of the peeled food product.

Furthermore, at a first slicing position the cutting edge of the cutting blade extends above a top surface of the spacer plate, whilst the cutting blade is substantially parallel to the spacer plate. At this position the top surface of the spacing plate slides against the food product as it is displaced thereabout.

According to a second slicing position, the cutting edge of the cutting blade extends below the bottom surface of the spacer plate, whilst the cutting blade is substantially parallel to the spacer plate. At this position the bottom surface of the spacing plate slides against the food product as it is displaced thereabout.

Hereinafter in the specification and claims the term cutting blade is used to denote an elongate blade used interchangeably for peeling, cutting, shredding (e.g. producing julienne strips, slivers and the like) etc.

The kitchen utensil is manipulable in two main positions, namely a peeling position and a slicing position.

The kitchen utensil of the presently disclosed subject matter can be configured with any one or more of the following features and designs, in combination or separately:

The frame is configured at a fore end of a gripping handle;

The gripping handle is ergonomically shaped for comfortable and safe gripping by an individual;

The gripping handle is configured with a juice squeezer at an aft end thereof;

The gripping handle is configured additional kitchen aid functions such as a bottle opener, garlic crusher, corer, pitter, knife sharpener, etc.;

The gripping handle is configured with at least one gliding surface on at least one face thereof, for guiding a food product towards the cutting blade;

The gripping handle is configured with gliding surface on each face thereof, for guiding a food product towards the cutting blade;

The kitchen utensil is configured with a container (e.g. bowl and the like) engaging portion, whereby the utensil can be engaged with the container, with the cutting blade and spacer plate extending over or within the container;

The engaging portion can be configured as a groove for mounting over a rim of the container;

The mounting groove at the container engaging portion may be further fitted with a knife sharpener;

At the slicing mode wall surfaces of the cutting blade extend substantially parallel with wall surfaces of the spacer plate;

The distance between the cutting blade and the spacer plate is adjustable, to thereby control slicing width;

The kitchen utensil is configured for using at two distinct slicing modes in which the utensil is held at a different orientation;

The cutting blade is configured with a first cutting edge facing the spacer plate, and a second cutting edge, wherein that it can be inverted upon blunting of the first cutting edge such that the second cutting edge now faces the spacer plate;

One or both cutting edges of the cutting blade are patterned, e.g. undulating, serrated;

The device can be used as a shredder for shredding food articles; a shredding blade can be mounted on the frame or on the spacer plate, said shredding blade comprising one or more blades extending substantially normal to the cutting blade at its slicing position;

The shredding blade can be detachably attachable to the frame, e.g. by at least partially enveloping the cutting blade.

Mutual pivotal displacement of the cutting edge and the spacer plate is restricted to thereby obtain fixed angular positions therebetween;

The cutting blade and the spacer plate are pivotally secured to the frame so as to follow the counter of the food product as the utensil is moved there along;

One face of the cutting blade can be configured with a plurality of upright extending blades, the other face of which configured for longitudinal slicing, for fine shredding of food products;

The cutting blade can be arced or otherwise shaped (e.g. V-like shaped); the spacer plate can follow the shape of the cutting blade, however maintaining a constant distance therebetween;

The cutting blade and the spacer plate are pivotally loose within a limited range and are self aligned upon applying over a surface of a food product;

Pivotal displacement of the cutting blade and the spacer plate is restricted by restricting members cooperating with corresponding stoppers configured at the frame;

The cutting blade and the spacer plate are mutually pivotally displaceable, whereby at the peeling position the angular position of the cutting blade with respect to the spacer plate is substantially predetermined and constant, said angle defined by the spacer plate gliding over the food product;

The cutting blade and the spacer plate are pivotally self aligning such that at a slicing position surfaces of the spacer plate are parallel with surfaces of the cutting blade;

The utensil may be provided with a support member adapted to support the utensil at an angle on a surface. Such a support member may be in a form of at least one foldable leg, adapted to be folded over the utensil and to be flush with the surface thereof.

The utensil may be configured as having two parts: a handle portion and an operational portion fitted with the frame. According to this example, the handle part may be fitted with a blade receivable within the body of the operational part. In an assembled position the two parts are adjoining and the blade is received within the operational part. In a disassembled position, the handle portion fitted with the blade is functional as a knife

The kitchen utensil is dishwasher safe.

### BRIEF DESCRIPTION OF THE DRAWINGS

In order to understand the disclosed subject matter and to see how it may be carried out in practice, embodiments will now be described, by way of non-limiting examples only, with reference to the accompanying drawings, in which:

FIG. 1A is a rear isometric view of a kitchen utensil according to a first example of the present disclosed subject matter;

FIG. 1B is front, bottom isometric view of the kitchen utensil of FIG. 1A;

FIG. 1C is rear, bottom view isometric view of the kitchen utensil of FIG. 1A;

FIG. 1D is front, top view isometric view of the kitchen utensil of FIG. 1A;

FIG. 2A is an enlargement of a head portion of the kitchen utensil of FIG. 1A, at a peeling position;

FIG. 2B is an enlargement of a head portion of the kitchen utensil of FIG. 1A, at a first slicing position;

FIG. 2C is an enlargement of a head portion of the kitchen utensil of FIG. 1A, at a second slicing position;

FIGS. 3A, 3B and 3C are schematic representations of the kitchen utensil of FIGS. 1 and 2, at a peeling position, a first slicing position and a second slicing position, respectively;

FIGS. 4A and 4B are top and side views of the kitchen utensil at a peeling position;

FIGS. 5A and 5B are a bottom perspective view and a top perspective view, respectively, illustrating the kitchen utensil at a first slicing position;

FIGS. 6A and 6B are a top left and top right perspective views, respectively, illustrating the kitchen utensil at a second slicing position;

FIG. 7A illustrates the kitchen utensil mounted over an edge of a bowl;

FIG. 7B illustrates the kitchen utensil at the position of FIG. 7A, while in a slicing position;

FIGS. 8A, 8B and 8C are rear top, front top and front bottom perspective views, respectively, of a kitchen utensil according to a second example of the present disclosed subject matter;

FIG. 9 illustrates a modification of a kitchen utensil according to the first example;

FIG. 10 illustrates yet another modification of a kitchen utensil according to the first example;

FIG. 11 illustrates another modification of a kitchen utensil according to the first example;

FIGS. 12A and 12B illustrate a modification of a kitchen utensil according to the first example; and

FIG. 13 illustrates a modification of a kitchen utensil according to the first example in a disassembled configuration;

### DETAILED DESCRIPTION OF EMBODIMENTS

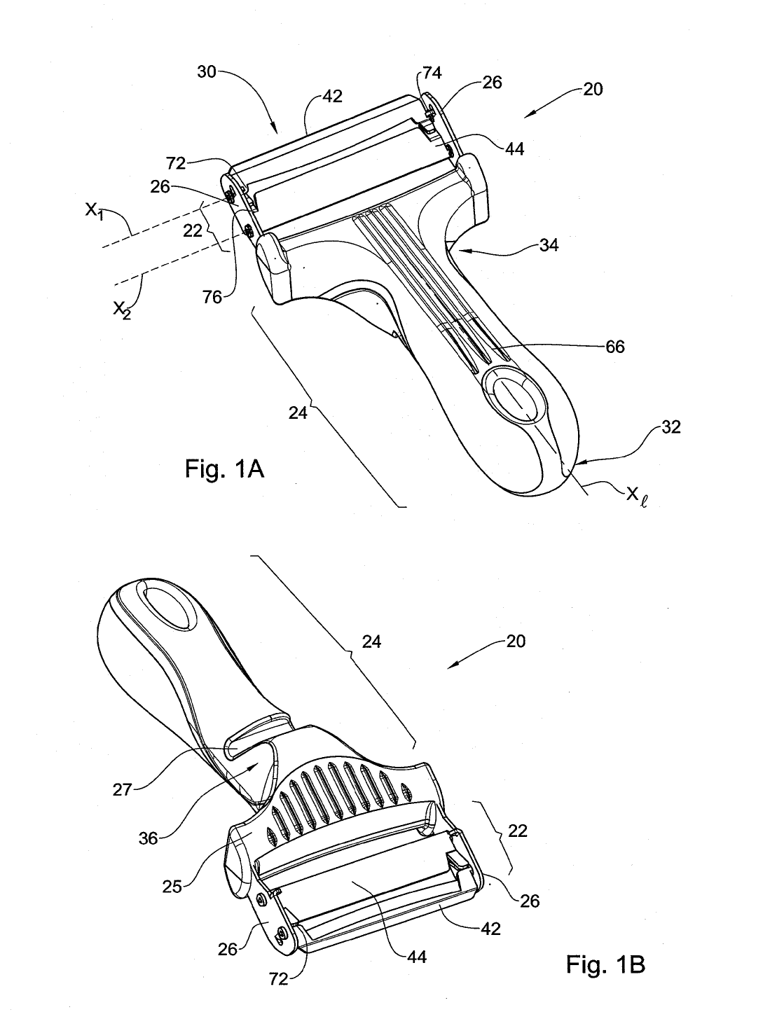

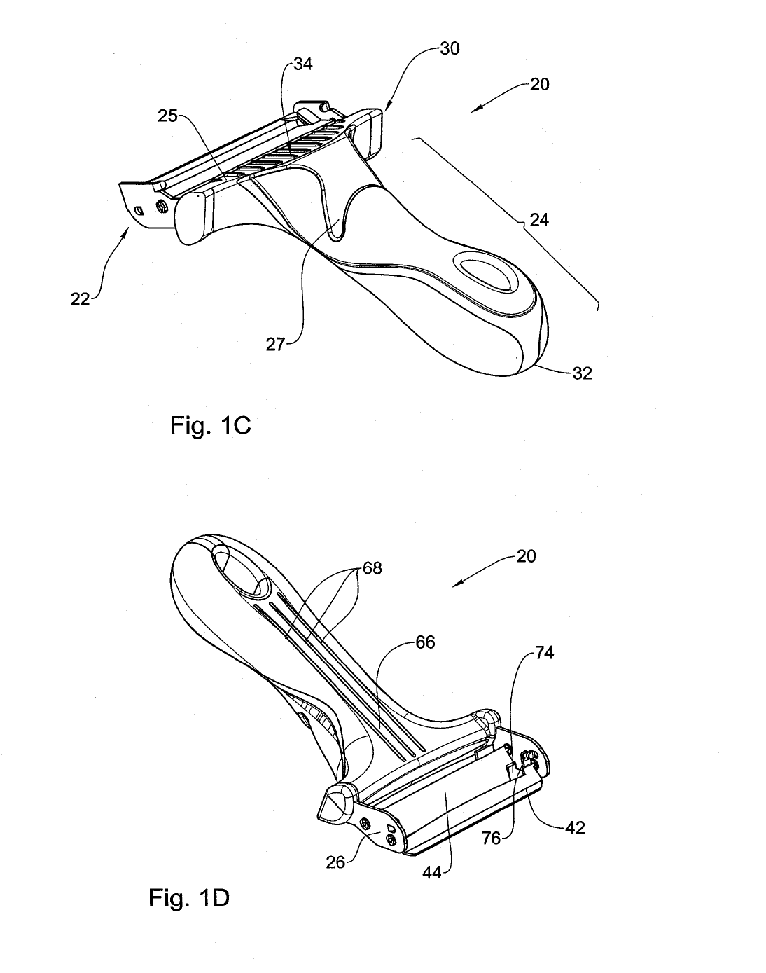

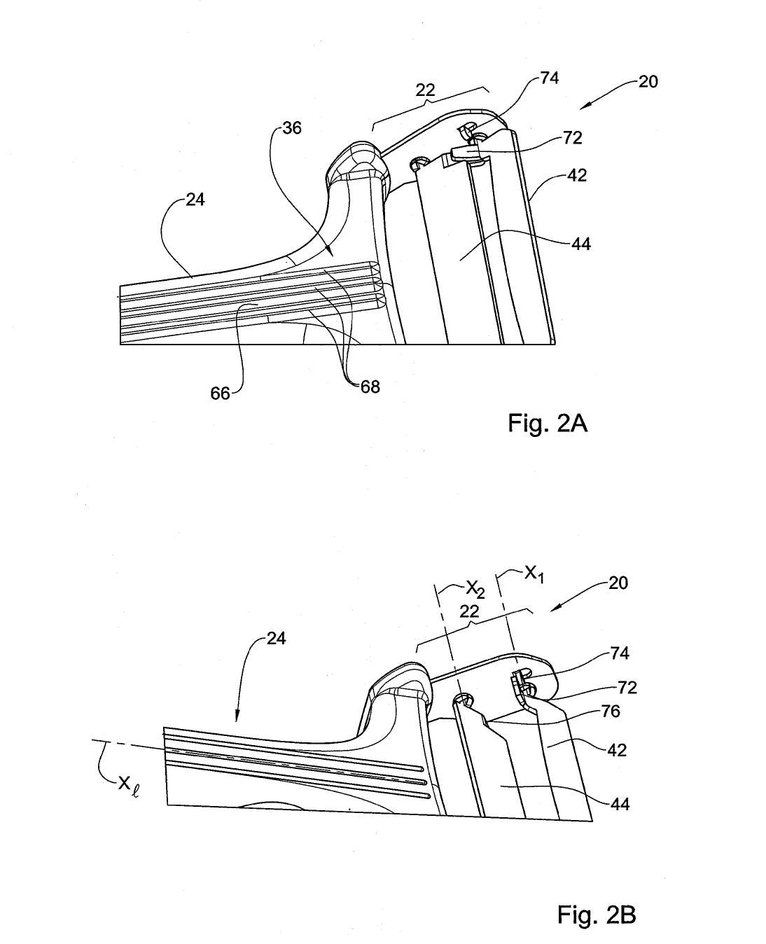

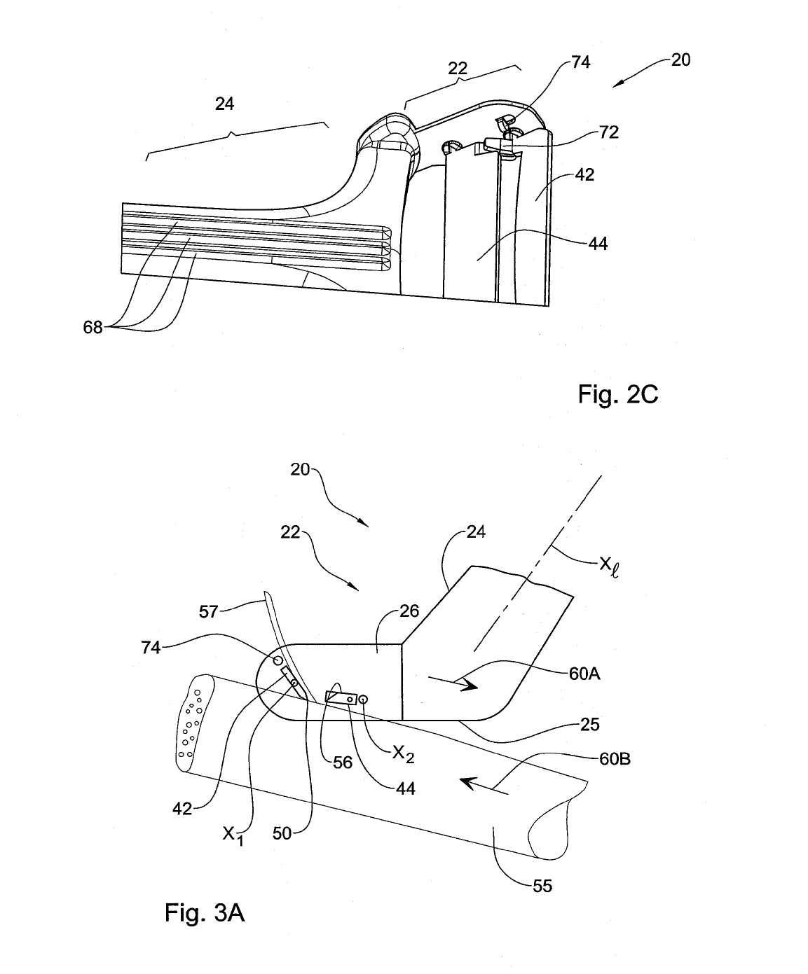

Attention is first directed to FIGS. 1 and 2 illustrating a kitchen utensil in accordance with the present disclosed subject matter generally designated 20. The kitchen utensil namely a peeler/slicer kitchen utensil is configured with a frame portion designated 22 extending at a fore end of a handle 24, said handle 24 designed and shaped ergonomically for comfortable and sturdy gripping by an individual.

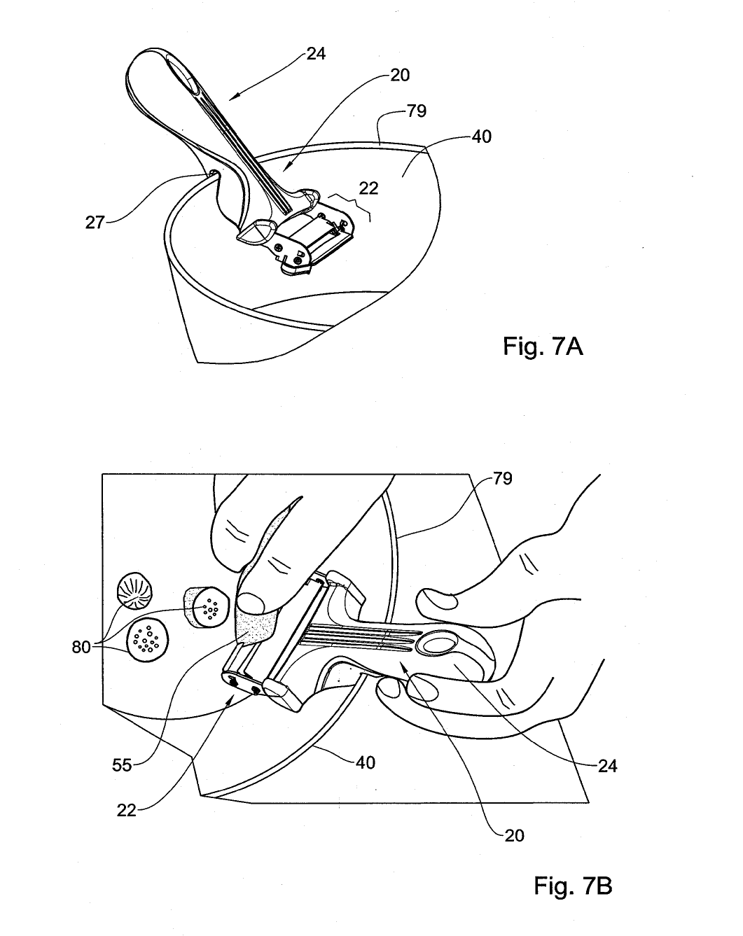

As can be seen, best in FIGS. 1B and 7A, the handle portion 24 is configured with a container engaging portion in the form of a shaped groove designated 27 configured such that the utensil can be engaged with a container, e.g. a bowl 40 such that the frame portion namely 22 extends over or within the container for a slicing operation as will be discussed hereinafter with reference to FIGS. 7A and 7B.

The kitchen utensil 20 is configured such that it has a fore end 30, and aft end 32, a top side 34 and a bottom side 36.

As can be seen in the drawings, the frame portion 22 is configured with two projecting side bars 26 extending substantially parallel to one another and pivotally supporting a cutting blade 42 near a front end of the utensil 20, and a spacer plate 44 extending behind said cutting blade. Cutting blade 42 is configured with a sharp cutting edge 50, whilst spacer plate 44 has blunt edges along a bottom surface 54 and a top surface 56, said bottom surface and top surface being substantially parallel to one another and smooth.

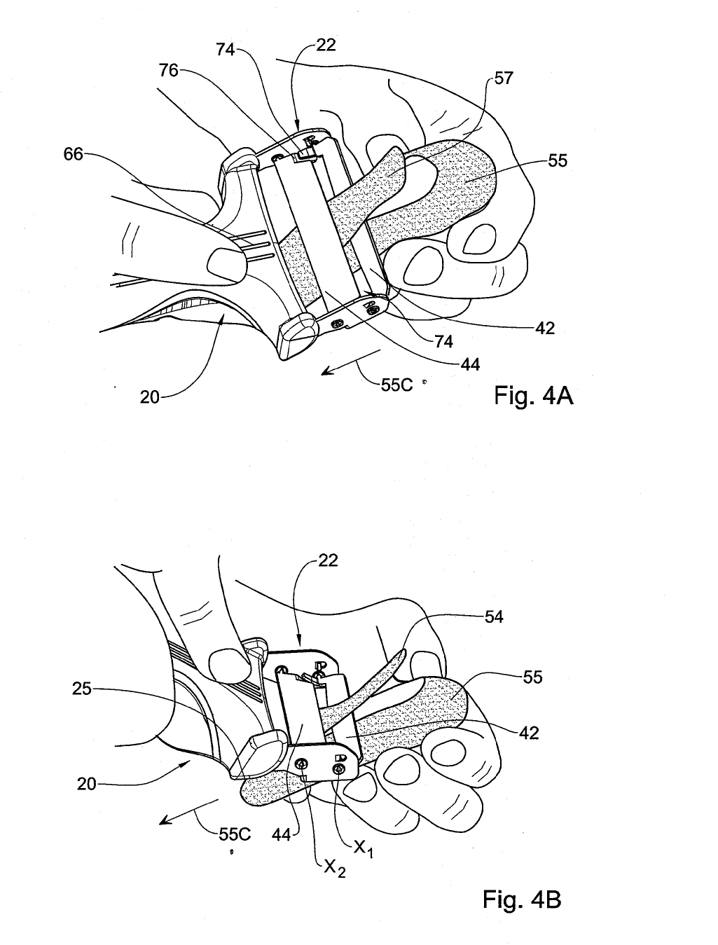

As can be seen, best in FIGS. 2A to 2C, the cutting blade 42 and the spacer plate 44 are pivotally mounted on the side bars 26 about parallely extending longitudinal axes (X₁ and X₂ , respectively, shown in FIGS. 1A and 2B), both of which being substantially perpendicular to a longitudinal axis X₁ of the handle portion 24, said cutting blade 42 and spacer plate 44 being pivotally displaceable between at least a peeling position (FIGS. 2C, 3A, 4A and 4B) and at least one, though two in the particular example, slicing positions (FIGS. 2B, 3B, 3C, 5A, 5B, 6B, 7B and 10), as will be discussed hereinafter in further detail.

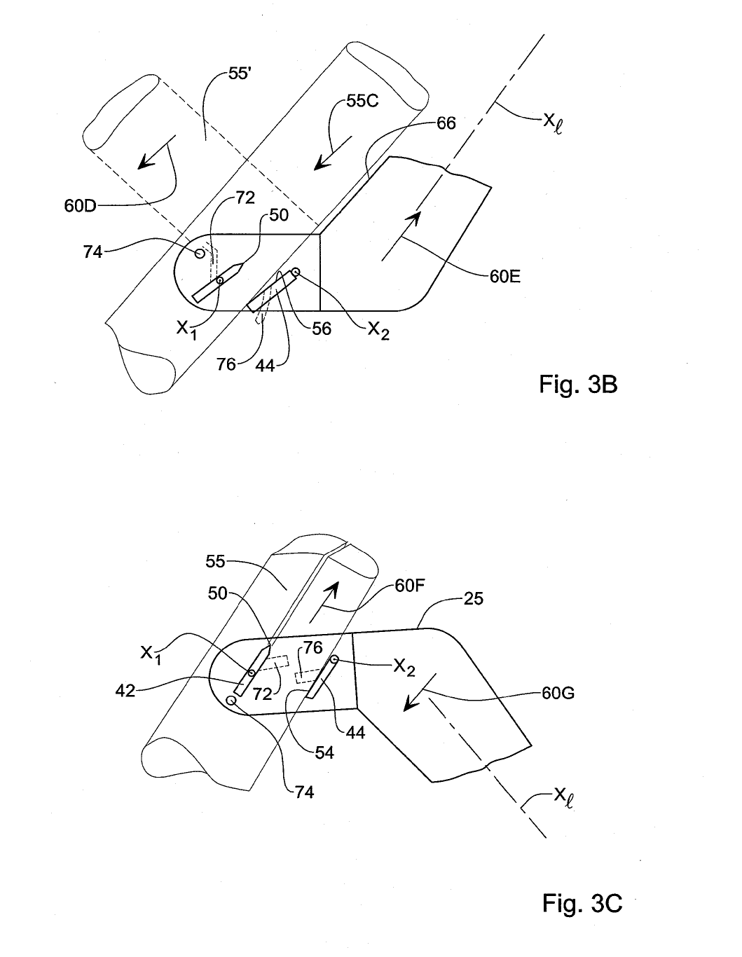

As can be seen in figures FIG. 3A, 4A and 4B, at the peeling position, the cutting blade 42 extends inclined with respect to the spacer plate 44 such that the cutting edge 50 of the cutting blade 42 extends below the bottom surface 54 of the spacer plate 44. Thus, at the peeling position the bottom surface 54 of spacer plate 44 is configured to follow, i.e. slide over an outer surface of the food product 55 being peeled, as illustrated in FIG. 3A, whilst the cutting edge 50 extends at an inclined position, however below said bottom surface 54, configured for penetrating into the food product 55, to a restricted depth only, so as to perform a smooth and clean peel of the food product 55, with the peal 57 emerging above the cutting blade 42.

In the pealing position the food product 55 is displaced in direction of arrow 60A or the kitchen utensil 20 is displaced over the food product 55 in direction of arrow 60B, with the food product 55 allowed to smoothly slide over glide surface 25 at a bottom side of the utensil 20.

It is further appreciated that at the peeling position the spacer plate 44 pivots into its position only upon applying the utensil over the food article and sliding it thereover (FIG. 2A), whereby the gap between the cutting blade 42 and the spacer plate 44 narrows. However, upon removing the utensil from the food article (i.e. at the end of a peeling stroke), the spacer plate 44 spontaneously displaces into its original position, thereby increasing the gap between the cutting blade 42 whereby the peel can easily disengage and loosely fall away, rendering the utensil ready for another peeling strike. It is appreciated that the spacer plate 44 spontaneously displaces into its original position under its self weight and possibly by the aid of a biasing member.

At a first slicing position (FIG. 3B) the cutting edge 50 of the cutting blade 42 extends above a top surface 56 of the spacer plate 44, whilst the cutting blade 42 is substantially parallel to the spacer plate 44. At this position the top surface 56 of the spacer plate 44 slides over the surface of the food product designated 55 as it is displaced thereabout.

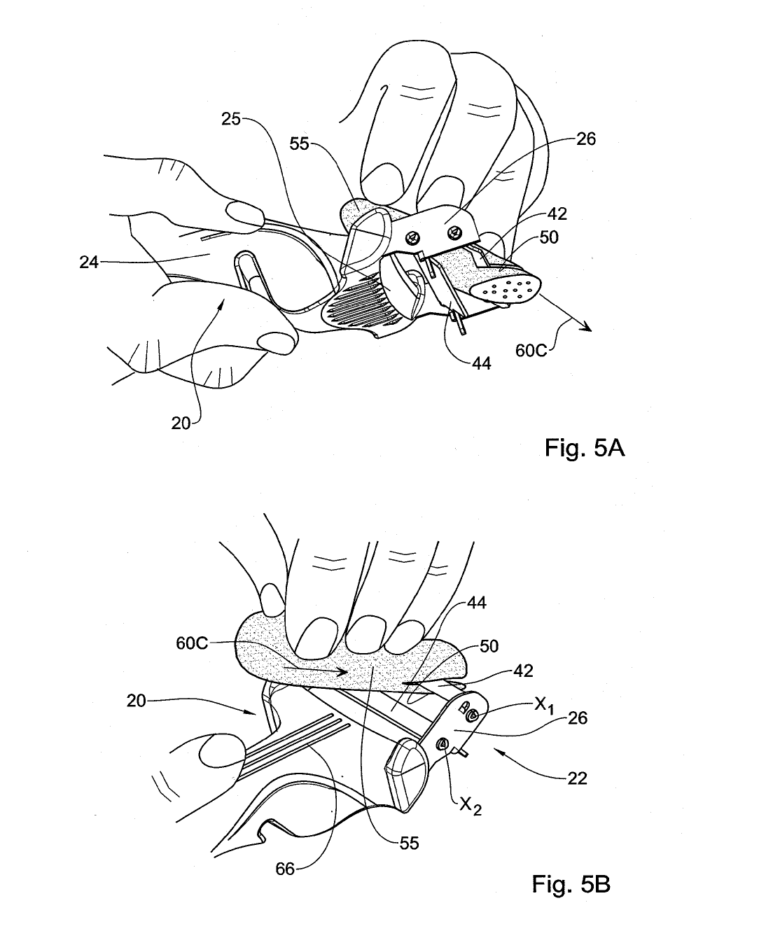

It is noted in FIG. 3B that the food product can be displaced in two principle positions, namely as illustrated by solid lines and designated 55 (illustrated in FIGS. 5A 5B), and by dashed lines and designated 55′ in which the food product is displaced substantially perpendicular to the position illustrated by solid lines.

At the first principle position the food product 55 is displaced along line 55C, and at the second principle position the food product 55′ is displaced along line 60D, wherein at both positions displacement is in direction towards the cutting edge 50. Alternatively the kitchen utensil 20 is displaced over the food product 55 in direction of arrow 60E.

At both said principle positions the food product 55 is allowed to easily slide over a gliding surface 66 configured over the top surface 34 of the handle portion, said gliding surface 66 configured with a plurality of directing ridges 68, though a smooth flat or curved surface can serve for the same purpose.

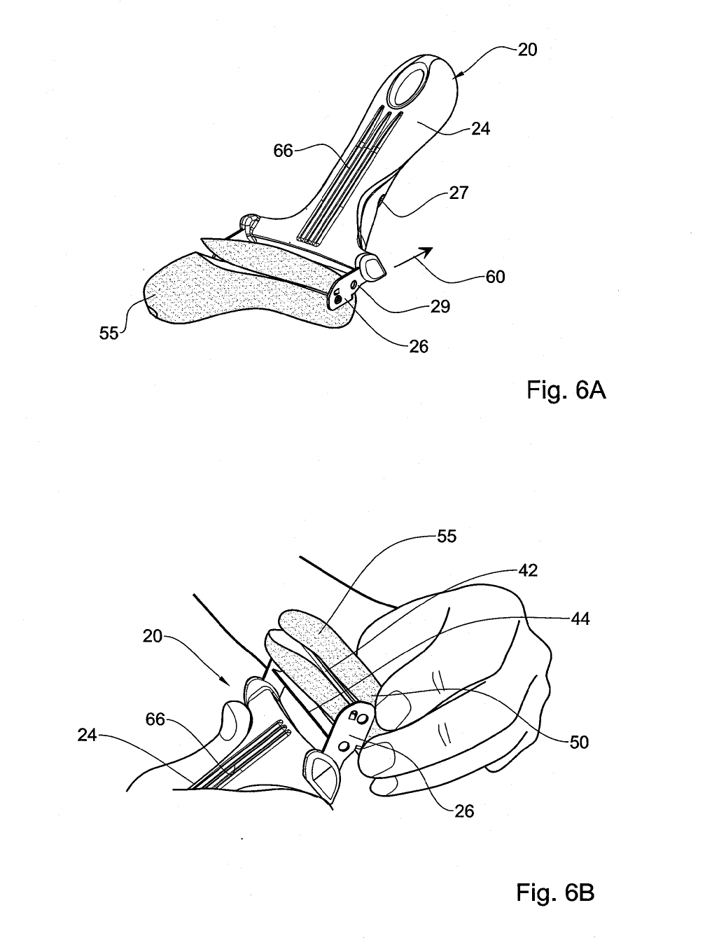

At a second slicing position (schematically represented in FIGS. 3C, 6A and 6B) the cutting edge 50 of the cutting blade 42 extends below the bottom surface 54 of the spacer blade 44, whilst the cutting blade 42 extends substantially parallel to the spacer plate 44. At this position the bottom surface 54 of the spacing plate 44 slides against the food product 55 as the latter is being displaced in direction of arrow 60F, or the kitchen utensil 20 is displaced over the food product 55 in direction of arrow 60G.

It is noted in the drawings that pivotal displacement of the cutting blade 42 and of the spacer plate 44 is restricted so as to retain a relation therebetween and with respect to the frame portion 22, according to the respective peeling/slicing position. This is obtained by restricting members cooperating with corresponding stoppers configured at the frame and at the respective cutting blade 42 and spacer plate 44.

For that purpose, the cutting blade 42 is configured with one or two projecting levers 72 configured for arresting by a stopper element 74 laterally projecting from an inside face of one or both of the arms 26. The arrangement is such that at the peeling position said lever 72 encounters said stopper element 74 thereby arresting it and preventing it from further pivotal displacement.

The spacer plate 44 is configured with one or two arresting members 76, bent out from the surface of the spacer plate 44, and configured for arresting the projecting levers 72 of the cutting blade 42, thereby fixing the angular position therebetween.

The arrangement is such that the cutting blade 42 and the spacer plate 44 are mutually pivotally displaceable, whereby at the peeling position the angular position of the cutting blade with respect to the spacer plate is substantially predetermined and constant, said angle defined by the spacer plate gliding over the food product.

It is appreciated that the cutting blade 42 and the spacer plate 44 are pivotally self aligning such that at a slicing position surfaces of the spacer plate are parallel with surfaces of the cutting blade 42.

Employing the device according to the second principal position (dashed lines) will result in slicing the food article in disc-like shapes, whilst using the device according to the first principal position of FIG. 2B, or as seen in FIG. 2C, will result in slicing the food article into elongate pieces. However the shape of the slices depends also on the angel at which the food article is displaced over the cutting blade.

In FIGS. 7A and 7B the kitchen utensil 20 is shown in use in conjunction with a bowl 40, wherein the grove 27 of the handle portion 24 is mounted over the edge 79 of the bowl 40 such that it is now supported thereby and with the frame portion 22 extending within the bowl. In this position a food article 55 is easily sliced, as illustrated in FIG. 7B, the slices 80 allowed to drop directly into the bowl 40.

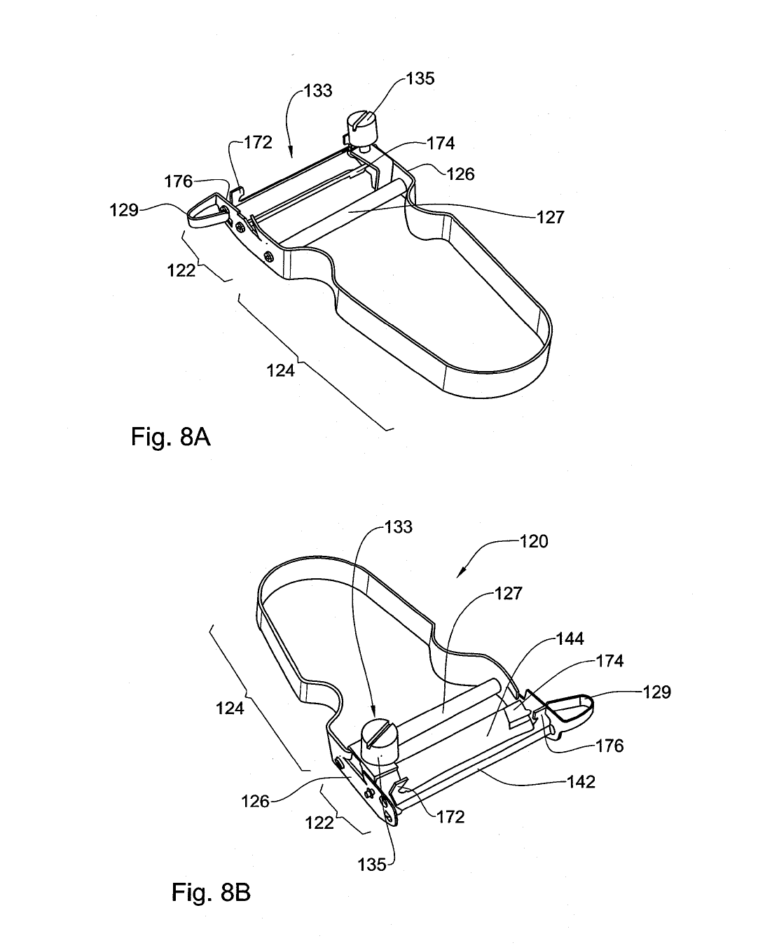

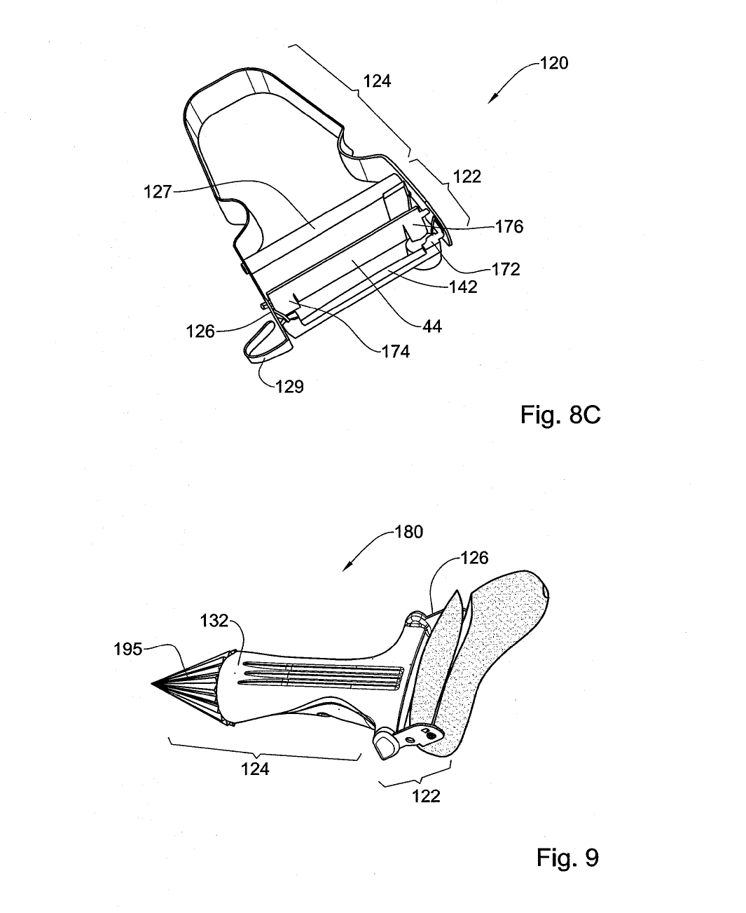

Turning now to FIGS. 8A to 8C there is illustrated a kitchen utensil 120 in accordance with a modification of the presently disclosed subject matter. For sake of clarity, elements similar to those disclosed in connection with the previous embodiment are designated with a like reference number, however shifted by 100.

The kitchen utensil 120 differs from the previous example in its general appearance, however has the same principal functional features. Instead of glide surface 25 and gliding surface 66 there is provided a bar 127 which acts both to rigidify the structure of the device and to provide a support/guidance while peeling/slicing a food item. In addition, the frame portion 122 is configured with a coring member 129, for coring and removing inedible portions of a food item.

However, the main difference resides in the provision of a thickness adjusting mechanism designated 133 in the form of a manually adjustable screw member 135 articulated to the frame portion 122 and configured for axially displacing against the spacer plate 144 to thereby restrict the angular pivotal range of the spacer bar. As indicated hereinabove in connection with the previous example, the cutting blade 142 and the spacer plate 144 are associated for restricted angular displacement owing to the restricting members, i.e. projecting levers 172 of the cutting blade 142, arresting members 176 bent out from the surface of the spacer plate 144, and the stopper element 174 of the spacer plate 144.

The arrangement is such that the cutting blade 142 and the spacer plate 144 are mutually pivotally displaceable, whereby at the peeling position the angular position of the cutting blade with respect to the spacer plate is substantially predetermined and constant, said angle defined by the spacer plate gliding over the food product.

In FIG. 9 there is illustrated a kitchen utensil 180 resembling that of the first example, however wherein the aft portion 132 is configured with a serrated juice-extracting portion 195 whereby juice can be squeezed from a fruit, e.g. a citrus fruit, etc.

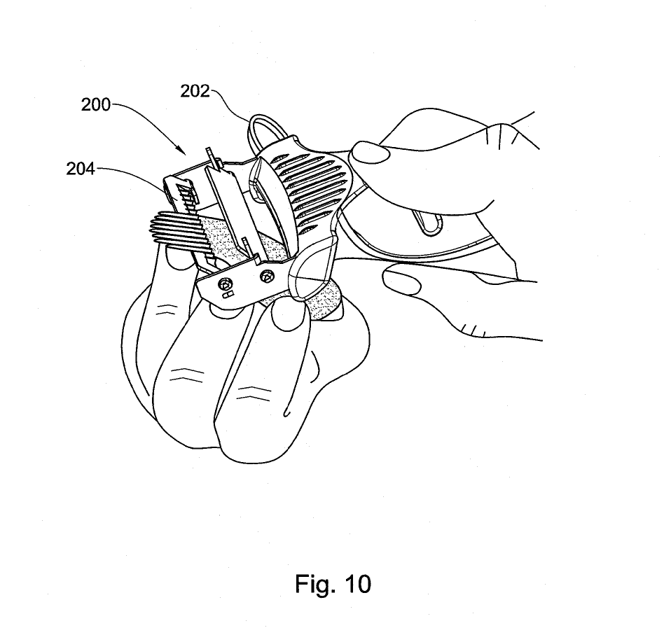

In FIG. 10 the kitchen utensil 200 is similar to the first example, however with the addition of a looped coring element 202 and a shredding element 204. The shredding element is a blade composed of several parallely extending blades, extending substantially normal to the spacer plate surface for shredding food articles. It is appreciated that the shredding blade 204 can be fixedly or removably mounted on the frame or on the spacer plate.

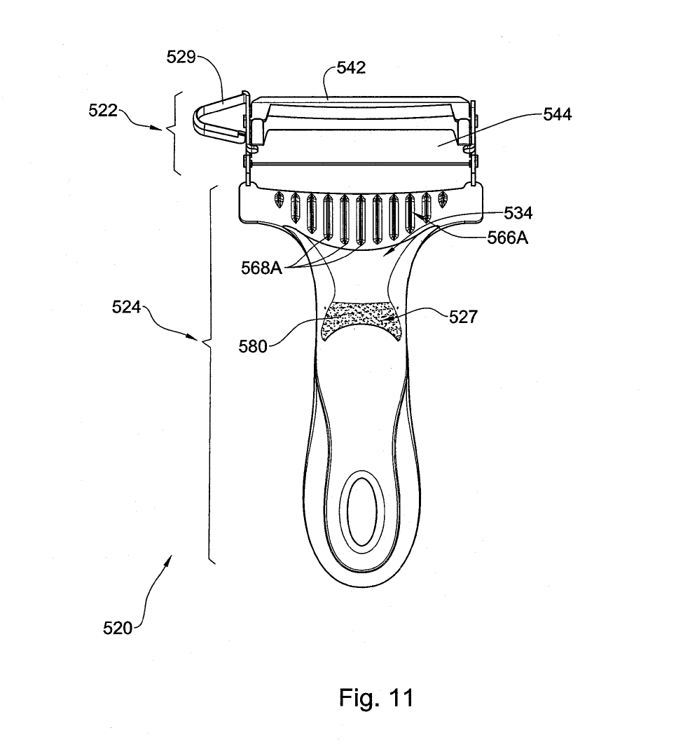

Turning now to FIG. 11 there is illustrated a kitchen utensil 520 in accordance with a modification of the presently disclosed subject matter. For sake of clarity, elements similar to those disclosed in connection with the previous embodiment are designated with a like reference number, however shifted by 500.

The kitchen utensil 520 differs from the previous examples in its general appearance, however has the same principal functional features. In this example the glide surface 566A is provided the bottom side 536 of the utensil 520. The gliding surface 566A provides a support/guidance while peeling/slicing a food item. In addition, the frame portion 522 is configured with a coring member 529, for coring and removing inedible portions of a food item.

Further illustrated in this figure is a knife sharpening surface configured at the grove 527 facilitating stoning of knife blade.

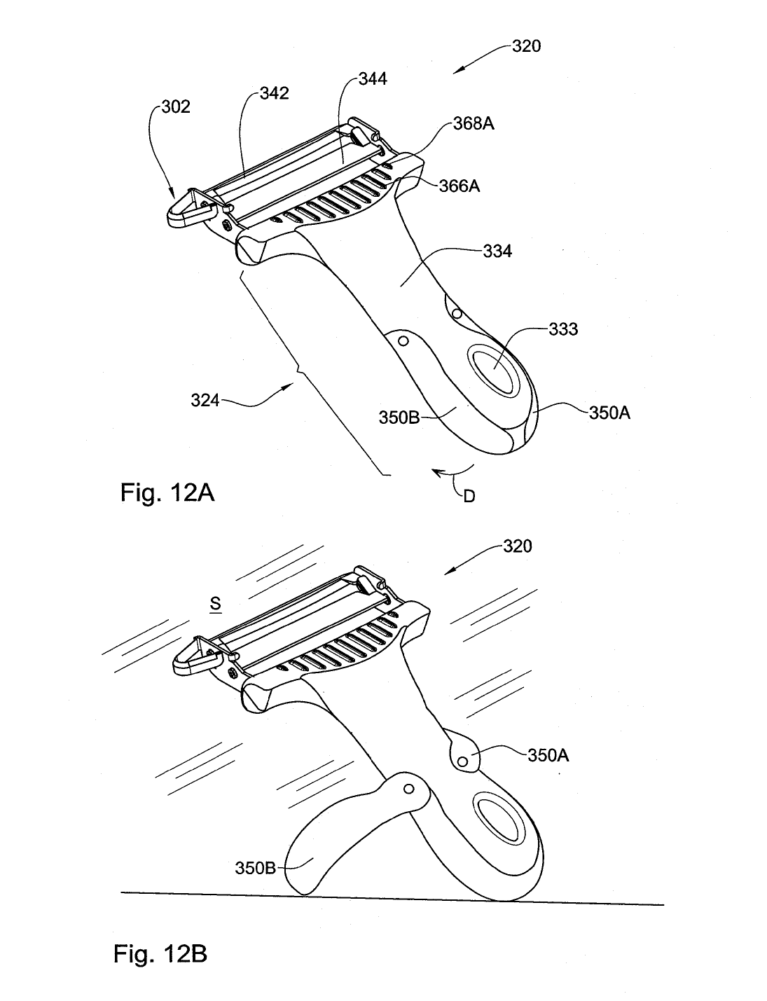

FIGS. 12A and 12B illustrate kitchen utensil 320 in accordance with a modification of the presently disclosed subject matter. For sake of clarity, elements similar to those disclosed in connection with the embodiment of FIG. 1A are designated with a like reference number, however shifted by 300.

The kitchen utensil 320 differs from the previous examples in its general appearance, however has the same principal functional features. In this example the glide surface 366A is provided the top side 334 of the utensil 320. In addition, the fore end is configured with two pivotally displaceable in the direction of arrow D support members 350A and 350B. The support members are displaceable between their first configuration seen in FIG. 12A with the members 350A and 350B being flush with the fore end of the handle and a second configuration in which the support members 350A and 350B are displaced to form elevation of the fore end of the handle from the surface S.

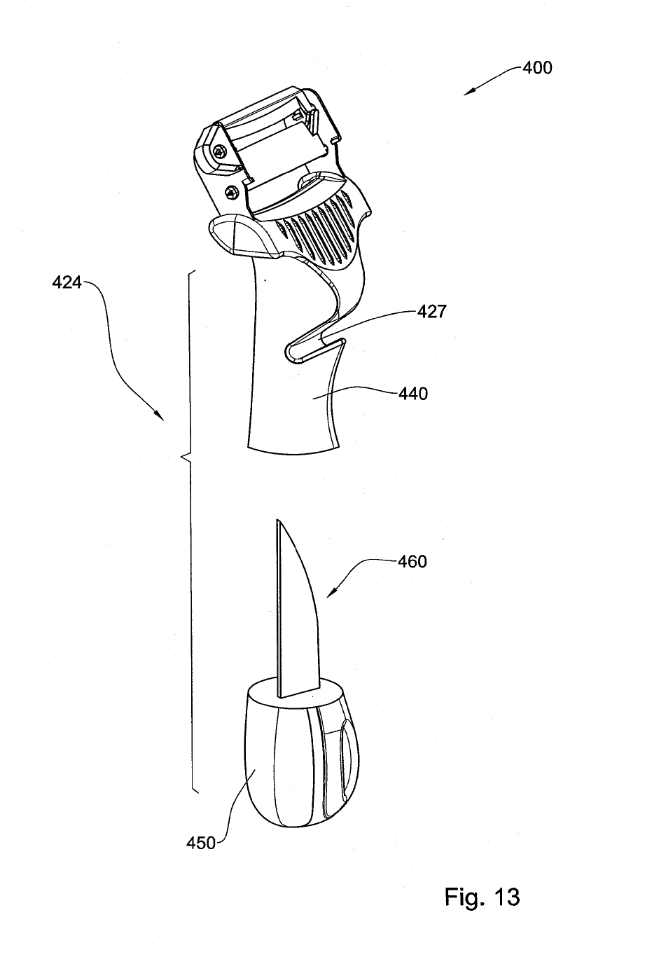

FIG. 13 illustrates a kitchen utensil 400 in accordance with a modification of the presently disclosed subject matter. For sake of clarity, elements similar to those disclosed in connection with the embodiment illustrated in FIG. 1A are designated with a like reference number, however shifted by 400.

The kitchen utensil 400 differs from the previous examples in its general appearance, however has the same principal functional features. In this example the kitchen utensil 400 is comprised of two parts 440 and 450. The utensil is fitted with a blade 460 fitted at the handle portion 450 of the utensil such that the blade is receivable within the body part 440 of the utensil. When disengaged, the handle part 450 is operational as a knife with the blade 460 forming the knife blade.

Whilst several embodiments have been described and illustrated with reference to the accompanying drawings, the artisan will appreciate that many variations are possible, which do not depart from the general scope of the present disclosed subject matter, mutatis mutandis

1. A handheld kitchen utensil, comprising: a frame; a cutting blade; and a spacer plate, the cutting blade and the spacer plate being pivotally mounted to the frame, said cutting blade and spacer plate being pivotally displaceable between at least a peeling position and at least one slicing position.

2. The handheld kitchen utensil according to claim 1, wherein the cutting blade and the spacer plate, are both mounted about parallel extending axes.

3. The handheld kitchen utensil according to claim 1, wherein at the peeling position the cutting blade extends inclined with respect the spacer plate such that a cutting edge of the cutting blade extends below a bottom surface of the spacer plate.

4. The handheld kitchen utensil according to claim 1, wherein at one of the at least one slicing positions, a cutting edge of the cutting blade extends above a top surface of the spacer plate, where the cutting blade is substantially parallel to the spacer plate.

5. The handheld kitchen utensil according to claim 1, wherein at one of the at least one slicing positions, a cutting edge of the cutting blade extends below the bottom surface of the spacer plate, while the cutting blade is substantially parallel to the spacer plate.

6. The handheld kitchen utensil according to claim 1, wherein the frame is configured at a fore end of a gripping handle.

7. The handheld kitchen utensil according to claim 1, wherein the frame is configured at a fore end of a gripping handle and the gripping handle is ergonomically shaped.

8. The handheld kitchen utensil according to claim 1, wherein the frame is configured at a fore end of a gripping handle and the gripping handle is configured with a juice squeezer at an aft end thereof.

9. The handheld kitchen utensil according to claim 1, wherein the frame is configured at a fore end of a gripping handle and the gripping handle is configured with at least one gliding surface on at least one face thereof, for guiding a food product towards the cutting blade.

10. The handheld kitchen utensil according to claim 1, wherein the kitchen utensil is configured with an engaging portion, whereby the utensil can be engaged with a container, with the cutting blade and spacer plate extending over or within the container.

11. The handheld kitchen utensil according to claim 1, wherein a distance between the cutting blade and the spacer plate is adjustable, to thereby control slicing width.

12. The handheld kitchen utensil according to claim 1, wherein the kitchen utensil is configured for use at two distinct slicing modes in which the utensil is held at a different orientation.

13. The handheld kitchen utensil according to claim 1, wherein the cutting blade is configured with a first cutting edge facing the spacer plate, and a second cutting edge, wherein the cutting blade can be inverted upon blunting of the first cutting edge such that the second cutting edge faces the spacer plate.

14. The handheld kitchen utensil according to claim 1, further comprising a shredding blade mounted on the frame or on the spacer plate, said shredding blade comprising one or more blades extending substantially normal to the cutting blade in its slicing position.

15. The handheld kitchen utensil according to claim 1, wherein one face of the cutting blade is configured with a plurality of upright extending blades, and the other face of which is configured for longitudinal slicing, for fine shredding of food products.

16. The handheld kitchen utensil according to claim 1, wherein the cutting blade and the spacer plate are pivotally loose within a limited range and are self aligned upon contact over a surface of an object.

17. The handheld kitchen utensil according to claim 1, further comprising restricting members wherein pivotal displacement of the cutting blade and the spacer plate is restricted by the restricting members cooperating with corresponding stoppers configured at the frame.

18. The handheld kitchen utensil according to claim 1, wherein the cutting blade and the spacer plate are mutually pivotally displaceable, whereby at the peeling position the angular position of the cutting blade with respect to the spacer plate is substantially predetermined and constant, said angle defined by the spacer plate gliding over the food product.

19. The handheld kitchen utensil according to claim 1, wherein the cutting blade and the spacer plate are pivotally self aligning such that at a slicing position surfaces of the spacer plate are parallel with surfaces of the cutting blade.
